(19) United States
(12) Patent Application Publication
(10) Pub. No.: US 2010/0277822 A1
(43) Pub. Date: Nov. 4, 2010

(54) Method and Apparatus to Facilitate Selection of a Digital Cinematic Content Write Process

(76) Inventors: Monte Davidoff, Cupertino, CA (US); John M. Moffat, Simi Valley, CA (US)

Correspondence Address: FITCH EVEN TABIN & FLANNERY, 120 SOUTH LASALLE STREET, SUITE 1600, CHICAGO, IL, 60603-3406, US

(21) Appl. No.: 12/667,844

(22) PCT Filed: Jul. 10, 2007
(86) PCT No.: PCT/US07/73159

§ 371 Date: Jul. 13, 2010

(51) Int. Cl. G11B 5/86

(52) U.S. Cl. 360/15; G9B/5.308

(57) ABSTRACT

A plurality of digital hard disc drives (201 and 209) are provided (101) that are intended to each receive precisely identical digital cinematic content. One of these digital hard disc drives is identified (102) as a primary source module (202) and a determination (103) then made regarding which of a single pass and a dual pass write process to use to write the digital cinematic content from the primary source module to each remaining one of the plurality of digital hard disc drives. This selected write process is then used (104) to write the digital cinematic content to each remaining one of the plurality of digital hard disc drives.

### RELATED APPLICATIONS

This invention relates generally to the following previously filed United States patent applications, the contents of which are incorporated herein by this reference:

CINEMATIC MEDIA CONTENT STORAGE SYSTEM INCLUDING A DIGITAL STORAGE MEMORY MODULE as filed on Jun. 24, 2005 (application Ser. No. 11/166,796);

DIGITAL STORAGE MEMORY MODULE APPARATUS AND METHOD as filed on Oct. 24, 2005 (application Ser. No. 11/257,384).

### TECHNICAL FIELD

This invention relates generally to digital cinematic content and more particularly to the creation of distributable copies of such content.

### BACKGROUND

Cinematic media content is well known in the art and typically comprises both visual imagery and synchronized audio material that is intended for public presentation and display in a theater setting before a potentially large audience. In the past, so-called film prints served exclusively as the storage, conveyance, and presentation vehicle for cinematic media content. Reels of such prints are typically physically conveyed from a point of distribution to a theater. A compatible projector then displays the corresponding cinematic media content on a presentation screen.

Such prints comprise an analog solution (for the most part; some prints include audio information in digital form) and therefore incur the fragility that characterizes such a medium. For example, film prints typically experience wear and tear with each showing. Over time, the resulting projected image becomes less pristine due to accumulated scratches, chemical changes, and breakage. Projection equipment also tends to be relatively complicated. This, in turn, tends to lead to a need for trained and skilled personnel to properly operate the projector when using film prints.

Digital versions of audio-visual content are of course known. Audio-visual content delivered via the Internet comprises one relatively ubiquitous example as are digital video discs (DVDs). The convenience, relative ease of use, and quality offered by digital renditions of cinematic content has not gone unnoticed by theater operators and this industry has taken numerous steps towards relying upon digital cinematic content as a primary means of distribution and display. Unfortunately, numerous obstacles continue to present themselves in this regard.

As but one example, for purposes of security, it will often be desirable to distribute physical copies of such digital cinematic content as the mechanism to facilitate providing theater operators with such product. Solutions have been posed in this regard that make use of readily reusable serial advanced transfer attachment (SATA) digital hard disc drives. With literally thousands of theater venues in the United States alone, however, a problem remains of populating a suitable number of such disc drives with the desired digital cinematic content in a timely and cost-efficient manner. A typical movie, for example, can comprise a relatively large quantity of digital information. As a result, writing such content to hundreds or even thousands of such hard disc drives can consume an unacceptable amount of time and/or infrastructure resources.

### BRIEF DESCRIPTION OF THE DRAWINGS

The above needs are at least partially met through provision of the method and apparatus to facilitate selection of a digital cinematic content write process described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a schematic block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a plurality of digital hard disc drives are provided that are intended to each receive precisely identical digital cinematic content. One of these digital hard disc drives is identified as a primary source module and a determination then made regarding which of a single pass and a dual pass write process to use to write the digital cinematic content from the primary source module to each remaining one of the plurality of digital hard disc drives. This selected write process is then used to write the digital cinematic content to each remaining one of the plurality of digital hard disc drives.

By one approach, this primary source module and a subset of the plurality of digital hard disc drives share a common housing. If desired, the remaining hard disc drives can themselves share one or more additional housings. In such a case, each aggregation of hard disc drives can further comprise a given hard disc drive that can serve as a target module and/or as a secondary source module.

If desired, these teachings will further accommodate making a decision regarding whether to use a single pass or a dual pass write process when writing digital cinematic content from the primary source module to the target modules. Such a determination can be based, for example, on the total number of digital hard disc drives that are to receive the digital cinematic content. So configured, for example, a single pass write process can be used when only a relatively few hard disc drives comprise the target modules. Conversely, a dual pass write process can be used when a relatively large number of hard disc drives comprise the target modules. This, in turn, permits selecting a write process that will accomplish the desired write task in a shortest amount of time.

So configured, those skilled in the art will understand and appreciate that these teachings facilitate the writing of digital cinematic content to a given population of recipient digital hard disc drives in a shortest overall amount of time. This, in turn, can facilitate speed to market, reduced duplication costs, and a higher degree of relative re-use of the duplicator facilities. Those skilled in the art will recognize and appreciate that these teachings are readily scaled and can accommodate a very high number of target modules while still nevertheless remaining temporally efficient when writing to only a relatively small number of target modules.

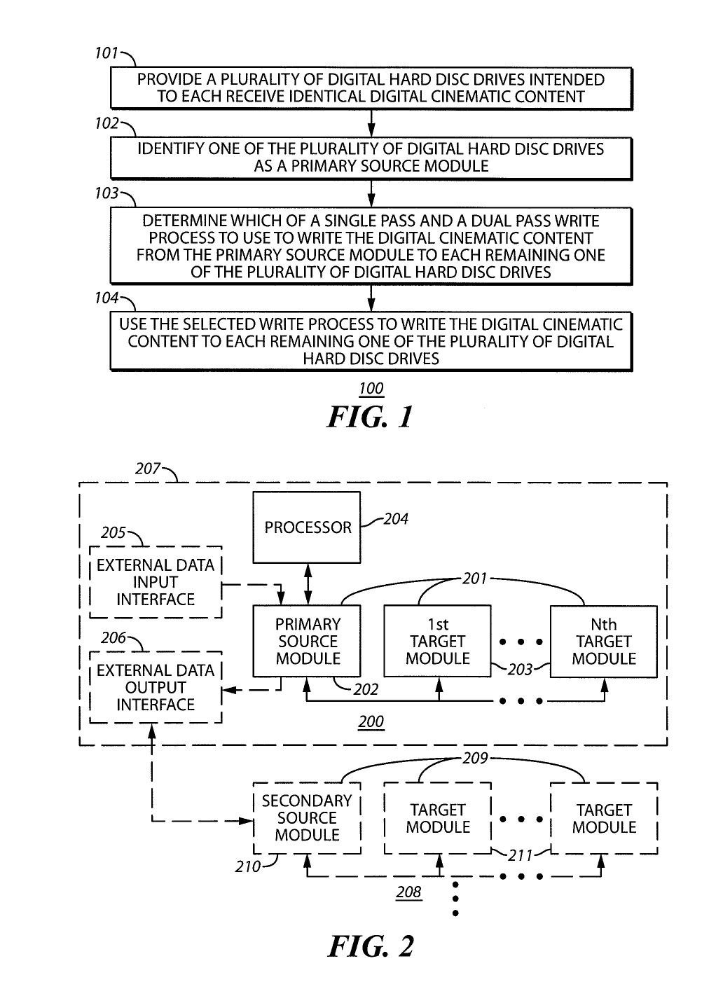

These and other benefits may become clearer upon making a thorough review and study of the following detailed description. Referring now to the drawings, and in particular to FIGS. 1 and 2, an illustrative 100 provides for provision 101 of a plurality of digital hard disc drives 201 that are intended to each receive precisely identical digital cinematic content. As used herein, “precisely identical” refers to the artistic content of the cinematic content and not necessarily to ancillary content such as digital watermarks, serial numbers, disc drive identifications, time stamps, or the like, which ancillary content very likely will vary on occasion. By one approach, these digital hard disc drives can comprise readily removable digital hard disc drives such as, but not limited to, readily removable serial advanced transfer attachment (SATA) digital hard disc drives. Being readily removable, such hard disc drives are easily then each sent to a different physical location to facilitate the playback of the aforementioned digital cinematic content.

By one approach, this step can comprise providing at least one housing 207 that is configured and arranged to house at least a predetermined plurality of the plurality of digital hard disc drives 201. When so configured, in many cases it may be beneficial to provide openings, drawers, or other means to permit the digital hard disc drives 201 to be easily placed within, or removed from, such a housing 207. Such housings and practices are known in the art. As the present teachings are not overly sensitive to the selection of any particular approach in this regard, for the sake of brevity further elaboration regarding such components will not be set forth here.

The total number of digital hard disc drives 201 so accommodated by a single housing 207 can vary with the needs, limitations, and/or opportunities as tend to characterize a given application setting. That said, and for the purposes of illustration, eight such digital hard disc drives 201 can be readily accommodated by such a housing that is itself configured and arranged to accommodate standard rack-mounting as is known in the art.

These teachings will readily accommodate providing more digital hard disc drives than can be reasonably or conveniently housed by a single housing. In such a case, at least some of the digital hard disc drives 209 may be disposed external to the aforementioned housing 207 and may, if desired, have their own housing or housings. For example, and to continue with the rack-mounting example posed above, a plurality of housings that each contain eight digital hard disc drives can be provided to meet the needs of a given application setting. By this approach, for example, thirteen such housings will serve to accommodate a sufficient number of digital hard disc drives to facilitate the making of over one hundred substantially simultaneous copies while one hundred and twenty-five such housings will accommodate a sufficient number of digital hard disc drives to facilitate the making of one thousand such copies.

This process 100 then provides for identifying 102 one of the plurality of digital hard disc drives to serve as a primary source module 202. The remaining digital hard disc drives can then serve as target modules 203. So configured, digital cinematic content as received by the primary source module 202 can then be provided, via a write process of choice, to each of the target modules 203. By one approach, this can include both the target modules 203 that share a housing 207 with the primary source module 202 as well as target modules 209 that do not. This, in turn, will permit the use of a single pass write process if desired, pursuant to which the content borne by the primary source module 202 is written substantially simultaneously to all such target modules.

To facilitate the movement of such content from the primary source module 202 to target modules that are external to the primary source module's housing 207, these teachings will accommodate providing each cluster of digital hard disc drives with an external data input interface 205 (to facilitate the receipt of such content) and an external data output interface 206 (to facilitate providing such content to a subsequent recipient as appropriate). So configured, for example, the primary source module 202 can receive digital cinematic content via its external data input interface 205 and provide that content to external target modules 209 via its external data output interface 206.

These teachings will also accommodate configuring and arranging at least one of the external target modules 209 for each cluster 208 of such modules to serve as a secondary source module 210. So configured, a dual pass write process can comprise the primary source module 202 writing the digital cinematic content to each of the secondary source modules 210 during a first write pass and then writing the digital cinematic content from each of the secondary source modules 210 to the remaining target modules 211 as correspond to each such secondary source module 210 during a second write pass. Although such a dual pass write process will tend to require more write time as compared to a single pass write process when writing to only a relatively few target modules (such as a few dozen target modules), the dual pass write process will prove more efficient and require less write time as compared to the single pass write process when writing to a relatively large number of target modules (such as many hundreds or thousands of target modules).

So configured, each such secondary source module can serve, during a dual pass write process, as a source of the digital cinematic content for remaining ones of the target modules as are also commonly housed with each such secondary source module. The particular write processes employed can of course vary with respect to the needs and/or opportunities as correspond to a given application setting. By one approach, however, it can be beneficial to employ a sector-by-sector write process (regardless of whether employing a single pass or a dual pass write process) to thereby tend to ensure that the digital hard disc drives are at least substantially identical on a sector by sector basis.

Also, and again regardless of whether a single pass or a dual pass write process is employed, these write processes may comprise so-called multi-casting write processes as are known in the art to facilitate a relatively reliable result. Such an approach will often provide, for example, for a two pass copy algorithm that provides a first pass to read and copy the source data and a second pass to read the copied data and compare the copied data to the source data to thereby confirm and verify the accuracy and veracity of the write process. (Those skilled in the art will understand that this two pass copy algorithm is not to be confused with the aforementioned dual pass write process.)

This process 100 then provides for determining 103 which of a single pass and a dual pass write process to use to write the digital cinematic content from the primary source module 202 to each remaining one of the plurality of digital hard disc drives 201 and 209. By one approach, a processor 204 of choice that operably couples to at least the primary source module 202 can serve to facilitate such a determination 103. If desired, such a determination 103 can be based, at least in part, upon the state of a user-assertable selection input. So configured, a user of the apparatus can determine in a given instance whether to employ the single pass or dual pass write process.

By another approach, however, such a processor 204 can be configured and arranged (via, for example, corresponding programming as will be well understood by those skilled in the art) to automatically make this determination. There are various criteria upon which such a determination 103 can be based. As one example in this regard, such a determination 103 can at least take into account a total number of digital hard disc drives that are to receive the digital cinematic content. As one illustration of this approach, the dual pass write process can be automatically selected when the total number of digital hard disc drives that are to receive the digital cinematic content exceeds a predetermined quantity (such as, for example, one hundred hard disc drives, five hundred hard disc drives, or the like).

This process 100 then provides for using 104 the selected write process to write the digital cinematic content to each remaining one of the plurality of digital hard disc drives. (Those skilled in the art will understand that this does not necessarily mean that all potentially available hard disc drives are written to; there may of course be application instances where a user does not wish to write to all available hard disc drives. Rather, this step refers to writing to all remaining hard disc drives that are, in fact, to be written to as per the requirements of a given task.) As with the determination step 103 described above, the process 204, when available, can be further employed to facilitate this step of using the selected write process as well.

When selecting the single pass write process, this step can comprise writing the digital cinematic content from the primary source module directly to each remaining digital hard disc drive. In such a case, the aforementioned secondary source modules are treated the same as the remaining target modules, with each such module simply receiving the digital cinematic content from the primary source module in a direct fashion.

When selecting the dual pass write process, this step can comprise, in a first pass, writing the digital cinematic content from the primary source module to at least one of the remaining digital hard disc drives that serves as a secondary source module and then, in a second pass, writing the digital cinematic content from the primary source module and the secondary source module(s) to remaining ones of the digital hard disc drives that have not yet received the digital cinematic content. (These teachings will also accommodate, if desired, using only the secondary source modules to write the digital cinematic content during the second pass of the dual pass write process, though such an approach may not offer any particular benefit in a typical application setting.)

As noted above, each secondary source module can write to a corresponding plurality of target modules (such as those target modules that share a common housing with a given secondary source module). So configured, by one approach, each secondary source module can be configured and arranged to write to N−1 digital hard disc drives where N comprises an integer larger than one (such that there will be one source module, primary or secondary, for each N of the digital hard disc drives). Given present form factors, N can have a value of eight and still yield an aggregated unit that is readily rack mountable.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Those skilled in the art will further recognize and understand that an apparatus as described herein may be comprised of a plurality of physically distinct elements as is suggested by the illustration shown in FIG. 2. It is also possible, however, to view this illustration as comprising a logical view, in which case one or more of these elements can be enabled and realized via a shared platform (though in a typical application setting it will likely be preferred that the various digital hard disc drives comprise discrete, readily removable components to facilitate their later distribution). It will also be understood that such a shared platform may comprise a wholly or at least partially programmable platform as are known in the art.

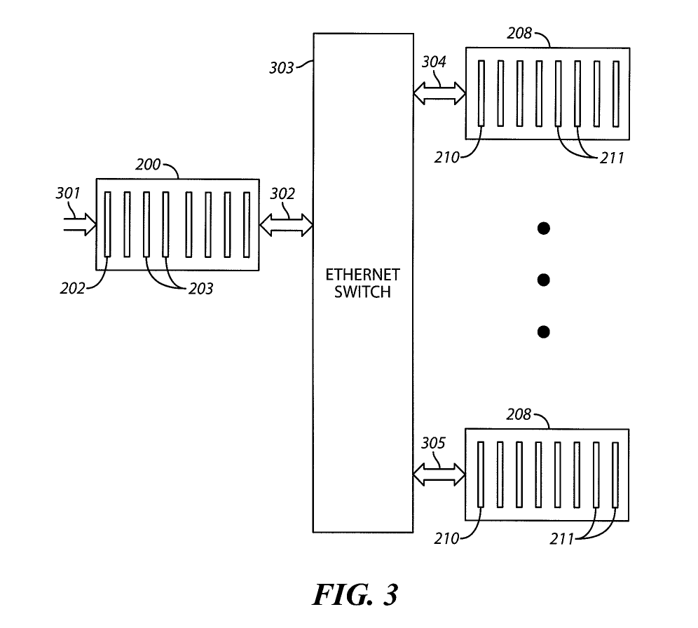

Those skilled in the art will understand that these teachings can be implemented and leveraged in a variety of ways. An illustration in this regard will now be provided with reference to FIG. 3. Those skilled in the art will recognize that this example serves only as an illustration and is not intended to serve as an exhaustive listing of all possible embodiments that will accord with these teachings.

In this illustrative example, a first unit 200 of eight digital hard disc drives comprises a primary source module 202 as described above and seven target modules 203. The primary source module 202 operably couples to an incoming data feed 301 that can comprise, for example, a one gigabit Ethernet feed as is known in the art. This incoming data feed 301 can couple to a digital cinematic content source of choice and serves as the primary mechanism for providing the digital cinematic content to the primary source module 202. A second one gigabit Ethernet link 302 then serves to couple the primary source module 202 to an Ethernet switch 303 which in turn couples to a plurality of other hard disc drive units 208 as described above via corresponding one gigabit Ethernet links such as the links denoted in the illustration by reference numerals 304 and 305.

So configured, the described apparatus can readily support the processes described herein. In particular, automated decisions can dictate whether the primary source module 202 writes the digital cinematic content to all of the remaining digital hard disc drives using a single pass write process or a dual pass write process. In either case, the digital cinematic content can be passed from the primary source module 202 to the other units 208 using the described Ethernet infrastructure. When using the dual pass write process, the primary source module 202 can write, during a first pass, the digital cinematic content to the secondary source modules 210 of the other units 208 following which, during a second pass, the digital cinematic content can be passed from the primary source module 202 to its constituent target modules 203 and from the various secondary source modules 210 to their corresponding constituent target modules 211.

So configured, these teachings permit great flexibility with respect to populating a highly variable number of hard disc drives with cinematic content to facilitate the theatrical distribution of such content via physical distribution of those hard disc drives. The overall time required to populate a given number of such hard disc drives for a given body of content can be generally minimized to thereby facilitate relatively speedy turnover, product availability, and reduced costs.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a plurality of digital hard disc drives intended to each receive precisely identical digital cinematic content;
identifying one of the plurality of digital hard disc drives as a primary source module;
determining which of a single pass and a dual pass write process to use to write the digital cinematic content from the primary source module to each remaining one of the plurality of digital hard disc drives to provide a selected write process;
using the selected write process to write the digital cinematic content to each remaining one of the plurality of digital hard disc drives.

2. The method of claim 1 wherein providing a plurality of digital hard disc drives comprises providing at least one housing configured and arranged to house at least a predetermined plurality of the plurality of digital hard disc drives.

3. The method of claim 2 wherein providing at least one housing configured and arranged to house at least a predetermined plurality of the plurality of digital hard disc drives comprises providing at least one housing configured and arranged to house at least a eight of the plurality of digital hard disc drives.

4. The method of claim 2 wherein providing at least one housing configured and arranged to house at least a predetermined plurality of the plurality of digital hard disc drives comprises providing a plurality of the housings.

5. The method of claim 4 wherein providing a plurality of the housings further comprises providing a plurality of the housings wherein at least one of the housings each has at least one data interface to facilitate receiving the digital cinematic content from another of the housings that houses the primary source module.

6. The method of claim 2 wherein the plurality of digital hard disc drives comprise readily removable digital hard disc drives.

7. The method of claim 6 wherein the readily removable digital hard disc drives comprise serial advanced transfer attachment (SATA) digital hard disc drives.

8. The method of claim 1 wherein determining which of a single pass and a dual pass write process to use to write the digital cinematic content from the primary source module to each remaining one of the plurality of digital hard disc drives to provide a selected write process comprises responding to a user-assertable selection input.

9. The method of claim 1 wherein determining which of a single pass and a dual pass write process to use to write the digital cinematic content from the primary source module to each remaining one of the plurality of digital hard disc drives to provide a selected write process comprises automatically determining which of a single pass and a dual pass write process to use to write the digital cinematic content from the primary source module to each remaining one of the plurality of digital hard disc drives to provide a selected write process.

10. The method of claim 9 wherein automatically determining which of a single pass and a dual pass write process to use to write the digital cinematic content from the primary source module to each remaining one of the plurality of digital hard disc drives to provide a selected write process comprises automatically determining which of a single pass and a dual pass write process to use to write the digital cinematic content from the primary source module to each remaining one of the plurality of digital hard disc drives to provide a selected write process as a function, at least in part, of a total number of the digital hard disc drives that are to receive the digital cinematic content.

11. The method of claim 10 wherein automatically determining which of a single pass and a dual pass write process to use to write the digital cinematic content from the primary source module to each remaining one of the plurality of digital hard disc drives to provide a selected write process as a function, at least in part, of a total number of the digital hard disc drives that are to receive the digital cinematic content comprises using the dual pass write process when the total number of the digital hard disc drives that are to receive the digital cinematic content exceeds a predetermined quantity.

12. The method of claim 1 wherein the single pass write process comprises writing the digital cinematic content from the primary source module directly to each remaining digital hard disc drive.

13. The method of claim 12 wherein the dual pass write process comprises:
writing the digital cinematic content from the primary source module to at least one of the remaining digital hard disc drives that serves as a secondary source module;
writing the digital cinematic content from the primary source module and the secondary source module to remaining ones of the digital hard disc drives that have not yet received the digital cinematic content.

14. The method of claim 13 wherein there is one of the source modules for each N of the digital hard disc drives, where N comprises an integer larger than one.

15. The method of claim 14 wherein N has a value of eight.

16. The method of claim 1 wherein the single pass and the dual pass write processes comprise sector-by-sector copy processes.

17. The method of claim 1 wherein the single pass and the dual pass write processes comprise two pass copy algorithms that provide for a first pass to read and copy source data and a second pass to read copied data and compare the copied data to the source data.

18. An apparatus comprising:
a plurality of digital hard disc drives wherein at least one of the digital hard disc drives comprises a primary source module and remaining ones of the plurality of digital hard disc drives comprise target modules intended to each receive precisely identical digital cinematic content;
a processor disposed operably coupled to at least the primary source module, wherein the processor is configured and arranged to:
determine which of a single pass and a dual pass write process to use to write the digital cinematic content from the primary source module to the target modules to provide a selected write process;
use the selected write process to write the digital cinematic content to each of the target modules.

19. The apparatus of claim 18 further comprising:
a first housing that houses at least the primary source module and some of the target modules.

20. The apparatus of claim 19 further comprising:
an external data output interface operably coupled to the primary source module such that the digital cinematic content can be provided from the primary source module to target modules that are disposed externally to the first housing.

21. The apparatus of claim 20 further comprising:
a second housing that is physically discrete from the first housing and that houses at least some of the target modules;
an external data input interface that is configured and arranged to be operably couplable to the external data output interface such that the digital cinematic content can be provided from the primary source module to the target modules that are housed by the second housing.

22. The apparatus of claim 21 wherein at least one of the target modules that are housed by the second housing is configured and arranged to selectively serve as a target module during the single pass write process and as a secondary source module during the dual pass write process.

23. The apparatus of claim 22 wherein the secondary source module serves as a source of the digital cinematic content for remaining ones of the target modules that are housed by the second housing during the dual pass write process.

24. The apparatus of claim 18 wherein the plurality of digital hard disc drives comprise readily removable digital hard disc drives.

25. The apparatus of claim 24 wherein the readily removable digital hard disc drives comprise serial advanced transfer attachment (SATA) digital hard disc drives.

26. The apparatus of claim 18 wherein the processor is further configured and arranged to determine which of a single pass and a dual pass write process to use to write the digital cinematic content from the primary source module to the target modules to provide a selected write process by responding to a user-assertable selection input.

27. The apparatus of claim 18 wherein the processor is further configured and arranged to determine which of a single pass and a dual pass write process to use to write the digital cinematic content from the primary source module to the target modules to provide a selected write process by automatically determining which of a single pass and a dual pass write process to use to write the digital cinematic content from the primary source module to the target modules to provide a selected write process.

28. The apparatus of claim 27 wherein the processor is further configured and arranged to automatically determine which of a single pass and a dual pass write process to use to write the digital cinematic content from the primary source module to the target modules to provide a selected write process by automatically determining which of a single pass and a dual pass write process to use to write the digital cinematic content from the primary source module to the target modules to provide a selected write process as a function, at least in part, of a total number of the target modules that are to receive the digital cinematic content.
